(19) United States
(12) Patent Application Publication
(10) Pub. No.: US 2014/0164226 A1
(43) Pub. Date: Jun. 12, 2014

(54) SOCIAL ELECTRONIC PAYMENT METHOD AND SYSTEM

(71) Applicant: Buy Accountless Ltd., Petach Tikva (IL)

(72) Inventor: Roey GORODISH, Petach Tikva (IL)

(73) Assignee: Buy Accountless Ltd., Petach Tikva (IL)

(21) Appl. No.: 13/950,296

(22) Filed: Jul. 25, 2013

Related U.S. Application Data
(60) Provisional application No. 61/691,822, filed on Aug. 22, 2012.

(51) Int. Cl. G06Q 20/10; G06Q 50/00

(52) U.S. Cl. CPC G06Q 20/102; G06Q 50/01
USPC 705/39

(57) ABSTRACT

The subject matter discloses a computer-implemented method, comprising: at an apparatus having one or more processing units and a memory: receiving a deposit order submitted from a payer account to a payee account; wherein the deposit order comprises a deposit amount; by the processing unit, automatically crediting the deposit amount to a payee account; receiving an electronic transaction order from the payee; wherein the electronic transaction order comprising an identification of a seller and wherein the electronic transaction order comprising a transaction amount; by the processing unit, calculating a payer commission fee from the transaction amount; by the processing unit, automatically crediting the payer account by the payer commission fee; and by the processing unit, automatically debiting a seller-account of the seller by the payer commission fee.

### BACKGROUND

The present disclosure relates to electronic transactions.

Barter is an old trading method. The essence of the barter is replacing a product and/or services with another product and or service. However, over the years, in order to simplify the trade, a payment method based on a circulation medium has been developed. The circulation medium has an agreed value that can be used for buying or selling any product or service.

At the beginning the circulation medium was based on products such as wheat, salt, silver and gold. The next step was the invention of the currency. The gold was the basis of the currency for the issuance of currency till the '70s of the last century (the “gold standard”).

However, in the modern world, states issue an official currency. The value of the official currency is typically higher than the value of the metal from which it is made.

Another payment method is the debit card/credit card. Using debit/credit card saves the consumer the need to take notes, coins and checks, and reduces business risks of robbery of cash and lack of coverage of the protests. However, typically the buyer and the seller have to pay high service charges.

Paying with a credit/debit card can be done by using the cards or by communicating the identification number of the card. The communicating of the identification number of the card can be done by a telephone call, over the internet, or via the cellular telephone. In some cases the merchants are enforced to encode the credit card number, for example, by using PCI encoding method. However the encoding leads additional costs to the businesses.

### BRIEF SUMMARY

One exemplary embodiment of the disclosed subject matter is a computer-implemented method, at an apparatus having a processing unit and memory, comprising: receiving a deposit order submitted from a payer account to a payee account; wherein the deposit order comprises a deposit amount; by the processing unit, automatically crediting the deposit amount to a payee account; receiving an electronic transaction order from the payee; wherein the electronic transaction order comprising an identification of a seller and wherein the electronic transaction order comprising a transaction amount; by the processing unit, calculating a payee commission fee from the transaction amount; by the processing unit, automatically crediting the payee account by the payee commission fee; and by the processing unit, automatically debiting a seller account of the seller by the payee commission fee. According to some embodiments, the method further comprising the steps of: by the processing unit, calculating a payer commission fee from the transaction amount; by the processing unit, automatically crediting the payer account by the payer commission fee; and by the processing unit, automatically debiting the seller account by the payer commission fee. According to some embodiments, the calculating of the payee commission fee being according to a type of transaction. According to some embodiments, the method further comprising the steps of storing data related to the deposit order in a data repository; associating the data with a first identification of the payee; and associating the data with a second identification of the payer. According to some embodiments, the method further comprises the step of automatically debiting the payee account by the transaction fee.

One other exemplary embodiment of the disclosed subject matter is a computer implemented method comprising: at an apparatus having one or more processing units and a memory: receiving a deposit order submitted from a payer account to a payee account; wherein the deposit order comprises a deposit amount; by the processing unit, automatically crediting the deposit amount to a payee account; receiving an electronic transaction order from the payee; wherein the electronic transaction order comprising an identification of a seller and wherein the electronic transaction order comprising a transaction amount; by the processing unit, calculating a payer commission fee from the transaction amount; by the processing unit, automatically crediting the payer account by the payer commission fee; and by the processing unit, automatically debiting a seller-account of the seller by the payer commission fee. According to some embodiments, the calculating of the payer commission fee being according to a type of transaction. According to some embodiments, the method further comprising the steps of storing data related to the electronic transaction order in a data repository; associating the data with a first identification of the payee; and associating the data with a second identification of the payer;

One other exemplary embodiment of the disclosed subject matter is an apparatus, the apparatus comprising: a receiving unit configured for receiving a deposit order submitted from a payer account to a payee account; wherein the deposit order comprises a deposit amount; and a processing unit, configured for automatically crediting the deposit amount to a payee account; wherein the receiving unit is further configured for receiving an electronic transaction order from the payee; wherein the electronic transaction order comprising an identification of a seller and wherein the electronic transaction order comprising a transaction amount; wherein the processing unit is further configured for calculating a payee commission fee from the transaction amount; for automatically crediting the payee by the payee commission fee; and for automatically debiting a seller account of the seller by the payee commission fee.

According to some embodiments, the processing unit is further configured for
calculating a payer commission fee from the transaction amount; automatically crediting the payer account by the payer commission fee; and automatically debiting the seller account by the payer commission fee. According to some embodiments the calculating the payee commission fee being according to a type of transaction. According to some embodiments, the apparatus further comprises a data repository configured for storing data related to the electronic transaction order; for associating the data with a first identification of the payee; and for associating the data with a second identification of the payer.
One other exemplary embodiment of the disclosed subject matter is a computer-implemented method, An apparatus; the apparatus comprising a receiving unit configured for receiving a deposit order submitted from a payer account to a payee account; wherein the deposit order comprises a deposit amount; and a processing unit configured for automatically crediting the deposit amount to a payee account; wherein the receiving unit is further configured for receiving an electronic transaction order from the payee; wherein the electronic transaction order comprising an identification of a seller and wherein the electronic transaction order comprising a transaction amount; wherein the processing unit is further configured for calculating a payer commission fee from the transaction amount; for automatically crediting the payer account by the payer commission fee; and for automatically debiting a seller-account of the seller by the payer commission fee.

According to some embodiments the apparatus, further comprises a data repository configured for storing data related to the electronic transaction order in a data repository; for associating the data with a first identification of the payee; and for associating the data with a second identification of the payer.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary block diagram of a system for electronic payment, in accordance with some exemplary embodiments of the subject matter;

FIGS. 2A-C show flowchart diagrams of a method for electronic payment, in accordance with some exemplary embodiments of the disclosed subject matter;

FIG. 3a shows an example of a transaction between employee a with employer B and employee b with employer A according to method known in the prior art;

FIG. 3b shows an example of an electronic transaction between employee a with employer B and employee b with employer A, in accordance with some exemplary embodiments of the disclosed subject matter;

FIG. 4 shows a first exemplary scenario for an electronic payment, in accordance with some exemplary embodiments of the disclosed subject matter; and

FIG. 5 shows a second exemplary scenario for an electronic payment, in accordance with some exemplary embodiments of the disclosed subject matter.

### DETAILED DESCRIPTION

An electronic payment method and system for facilitating a financial product for providing barter transactions are disclosed herein.

Banks and credit card companies provide the services of loans, savings and checking accounts.

Typically, payment for a service or for labor is performed by transferring the salary or the service fee from the account of the employer or the entity that requests the service to the account of the employee or the service provider. In some cases the salary is provided by a debit card which is used by the employee for purchasing. The payee then performs transactions from the account. Some of the transactions are performed by a credit card or by a debit card. Credit card companies charge the merchants high fees for transactions that are performed by credit cards or by debit cards (payees usually pay monthly fees). While most current transactions today are purely electronic; there is no justification for the high rate of “handling” fee that the banks and the credit card companies charge the account holders and the merchants.

In one example an employer pays to his employees via a bank account. The employee performs his transactions by using the bank account, by paying checks or by using a credit card that is associated with the bank account. In another example person A pays person B for a service or a merchant by transferring money to person's B account. Person B then purchases merchandises from his account by using a credit card.

Banks and credit card companies usually charge commission fees even for electronic transactions. Such commission fees may be not proportional to the actual cost of the electronic transaction to the bank or credit card companies.

There is thus a need for reducing the usage of banking and the credit card system in transactions in order to reduce commission fees.

Embodiments according to the present invention provide a system and a method in which any entity that is registered to the system can gain commission fees by purchasing from a seller that is registered to the system and by paying for a service, for labor or for a merchant to a second entity. The payer gains commissions fee when the payee performs a transaction with the seller. It should be noted that any entity can be registered as a payer and as a payee and as a seller simultaneously.

In one example entities A and B are merchants, entity a is an employee of entity A and entity b is an employee of entity B. Entity A can pay salary to entity a by depositing money to an escrow nominated by the operator of the system while entity a can purchase goods from entity B by using the deposit. In this case entity B is the seller that pays commission fees to entity A, to entity a and to the operator of the service for the purchase. In another case Entity B can pay salary to entity b by allocating a portion of the deposit received from Entity A (or by depositing money to an escrow nominated by the operator of the system) while entity b can purchase goods from entity A by using the deposit. In this case entity A is the seller that pays commission fees to entity B, to entity b and to the operator of the service for the purchase.

The commission fees that are deducted from the seller for the purchase may be significantly lower than the commission fees he would have paid to credit card companies had the purchase been done by the credit card companies.

According to some embodiments, the purchase is authenticated with a smart card, or by using the mobile phone or by using One Time password (OTP). According to some embodiments, the history of the purchases of the payee is stored in a data repository and is provided to the payee upon request. According to some embodiments, the history of the allocations of the payer is stored in a data repository and is provided to the payer upon request.

In one example an employee and employers register to the system. The employer transfers the salary or a portion of a salary of an employee that registered to the system. For example if the employer usually receives a monthly salary at the end of the month the employer transfers an amount of 10 working days to the account of the employee at the beginning of the month. The employee can use this amount for purchasing items or services from sellers that are registered to the system. Thus the employee can use the salary for purchasing before the end of the month. When the employee purchases from such a seller the account of the seller is credited by the amount of transaction and then is debited by 1% of the amount of the purchase, 0.25% of this debit is transferred to the account of the employer, 0.25% is transferred to the operator of the system and 0.5% is transferred to the account of the employee. Thus both the employer and the employee are credited for the purchase and the seller only pays a small commission and does not have to pay to the credit card company. It should be noted that any seller can also register as an employer and vice versa.

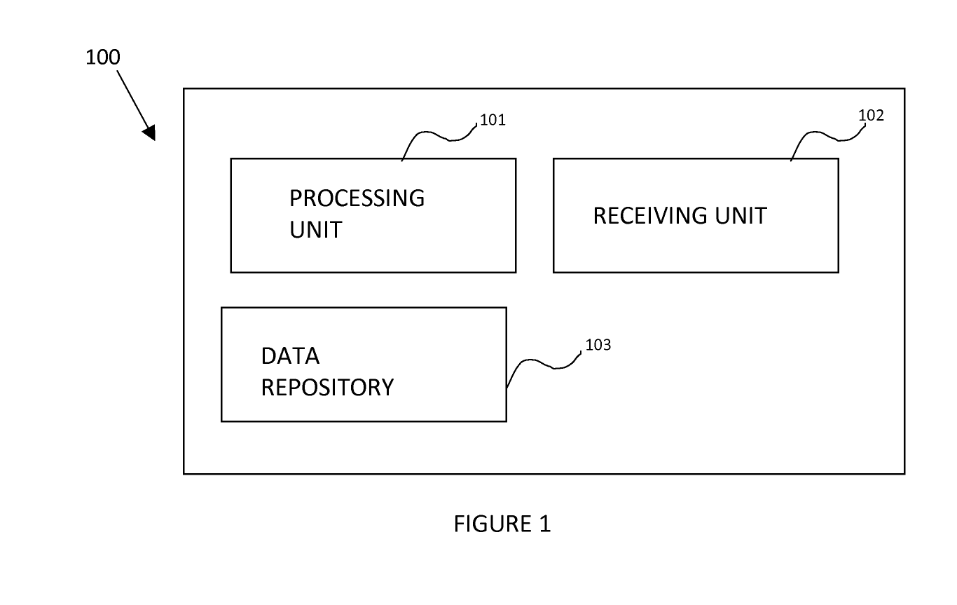

Referring now to FIG. 1 showing an exemplary block diagram of system for electronic payment, in accordance with some exemplary embodiments of the subject matter. System 100 comprises a processing unit 101, a receiving unit 102 and a data repository 103.

The receiving unit 102 is configured for receiving a deposit order submitted from a payer account to a payee account. The deposit order includes a deposit amount. The receiving unit 102 is further configured for receiving an electronic transaction order from the payee. The electronic transaction order includes an identification of a seller. The electronic transaction order includes a transaction amount.

The processing unit 101 is configured for automatically crediting the deposit amount to a list of payee accounts. The processing unit 101 is further configured for calculating a commission fee for the payee from the transaction amount and for automatically crediting the account of the payee by the commission fee for the payee. The processing unit 101 is further configured for automatically debiting the payee for the transaction amount. The processing unit 101 is further configured for automatically debiting a seller account by this commission fee. The processing unit 101 is further configured for calculating a commission fee for the payer from the transaction amount; for automatically crediting the payer account by this commission fee and for automatically debiting the seller account by this commission fee. The processing unit 101 is further configured for automatically crediting the account of the operator of the system by an operator fee and for automatically debiting the account of the seller by this fee.

The data repository 103 is configured for storing data related to the electronic transaction order. The data repository 103 is further configured for associating the data with an identification of the payee and for associating the data with an identification of the payer. The data repository 103 is further configured for associating data with another identification of another payer; thereby enabling a user of a system to receive money from a plurality of users.

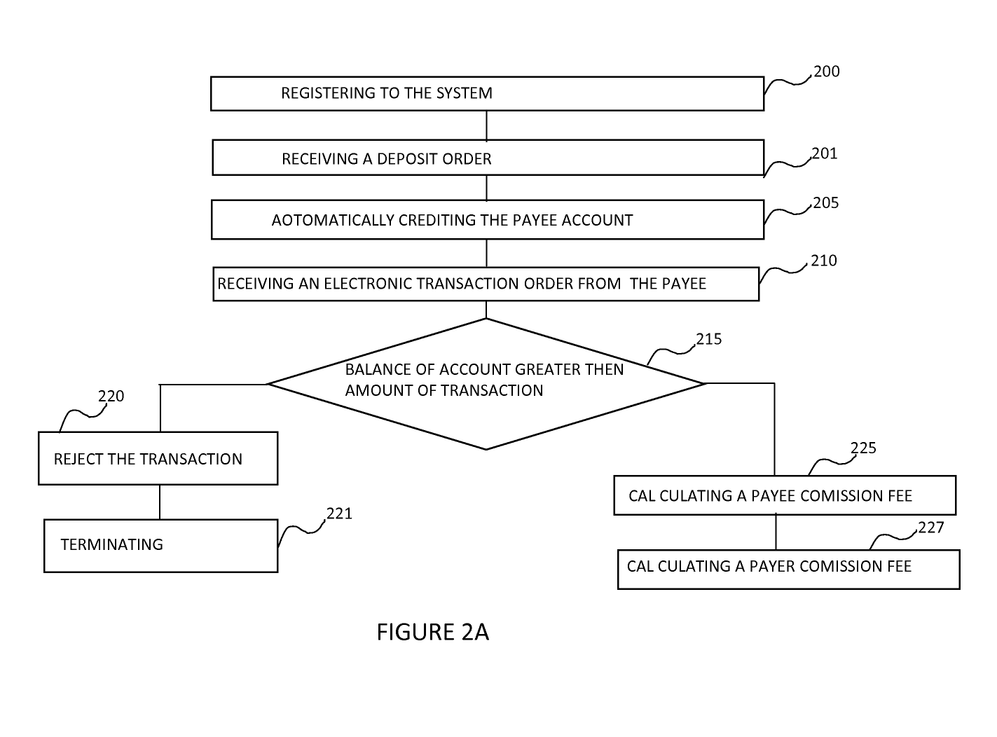

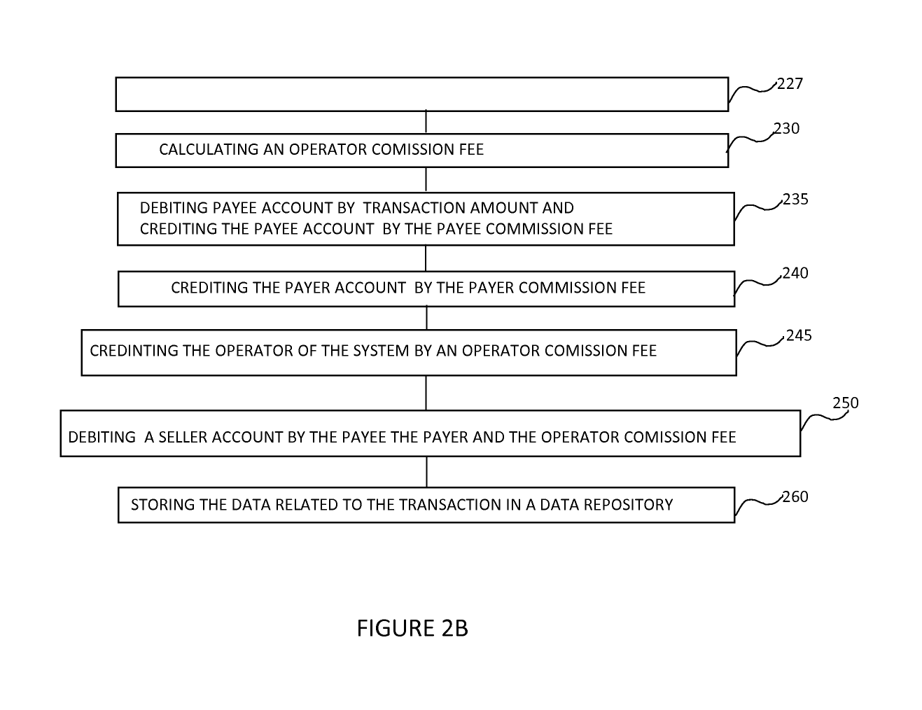

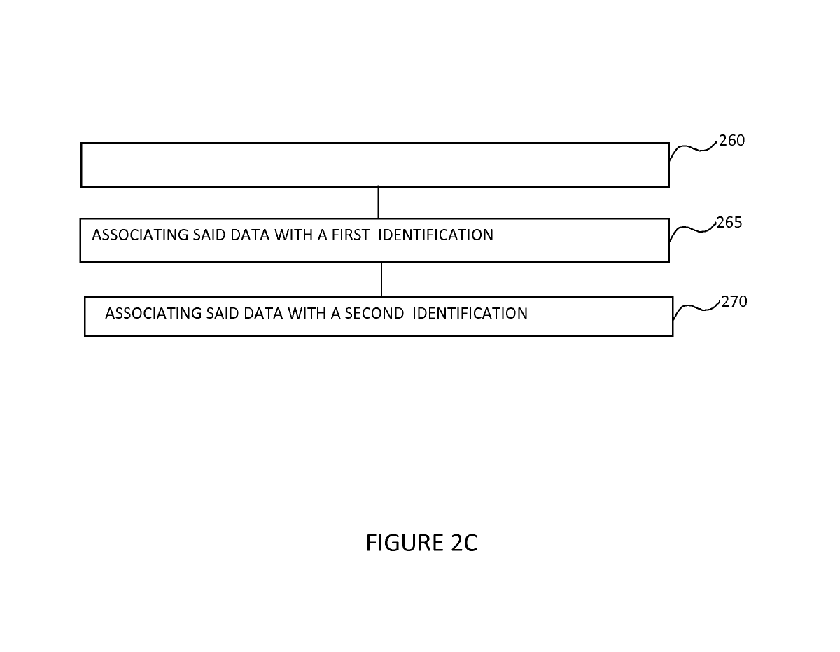

FIGS. 2A-C show flowchart diagrams of a method for electronic payment, in accordance with some exemplary embodiments of the disclosed subject matter.

At 200 the entities are registered to the system. According to some embodiments each entity can be registered as a payer, as a payee and as a seller. For example a car dealer can be register as a payer for paying his employees and as a seller for selling cars. An employee of the car dealer can be registered as a payee for receiving salaries or portions of salaries and for purchasing products and/or services via the system. The employee can also register as a payer for paying gifts to other system members through the system.

At 201 a deposit order is received from a payee to a payer. In some cases the deposit order is received from an employer who pays a portion or whole of the salary to an employee through the system. In some other cases the deposit order is received from an entity in return to a service that was provided by the payee. In some embodiments the deposit order is an order to transfer money from an external account to an account of the payee account. The external account is an account that is not managed by an operator of the system. In some other cases the deposit order is an order to transfer money from an account of the payer that is managed by the operator of the system.

At 205, the system automatically credits the payee account. In some embodiments the account is associated with the payer in order to credit the payer when the payee purchases through the account.

At 210 an electronic transaction order is received from the payee. The electronic transaction order is an order from the payee to buy a service or to buy goods. In some embodiments the transaction is authenticated by the system for example by authenticating a smart card that is used by the payee. The electronic transaction order includes an identification of a seller, an identification of the buyer (the payee) and an amount of the transaction.

At 215 the balance of the account of the payee is compared to the amount of the transaction. If the balance is not sufficient then the transaction is rejected at 220 the payee and the seller are automatically notified and the process is terminated at 221.

At 225 a payee commission fee for the payee is calculated. For example the payee commission fee may be 0.5% of the transaction amount. The calculating is according to a type of transaction. For example if the transaction is from one seller to another seller there may not be any commission fee. If the transaction is from a payee to another entity in the system (a gift) the rights for commission may be transferred to the other entity.

At 227 a payer commission fee for the payer is calculated. For example the commission fee may be 0.25% of the transaction amount. The calculating is according to a type of transaction. For example if the transaction is from one seller to another seller there may not be any commission fee.

At 230 an operator commission fee for the operator of the system is calculated. For example the operator commission fee may be 0.25% of the transaction amount.

At 235 the payee account is debited by the transaction amount and is credited by the payee commission fee. For example if the payee purchased an item for 25$, the payee will pay 25$-25$*0.5% which is 24.875$.

At 240 the payer account is credited by the payer commission fee. In the example, the payer account is credited by 0.0625$.

At 245, the operator of the system is credited by the operator commission fee. In the example, the operator of the system is credited by 25$*0.25%.

At 250 the seller is debited by the payee fee, the payer fee and the operator commission fee. In the example the seller is debited by 25*1%.

At 260 the data related to the electronic transaction order is stored in a data repository. Such data can be used for generating a history file of the payee for example for providing credit history for the payee.

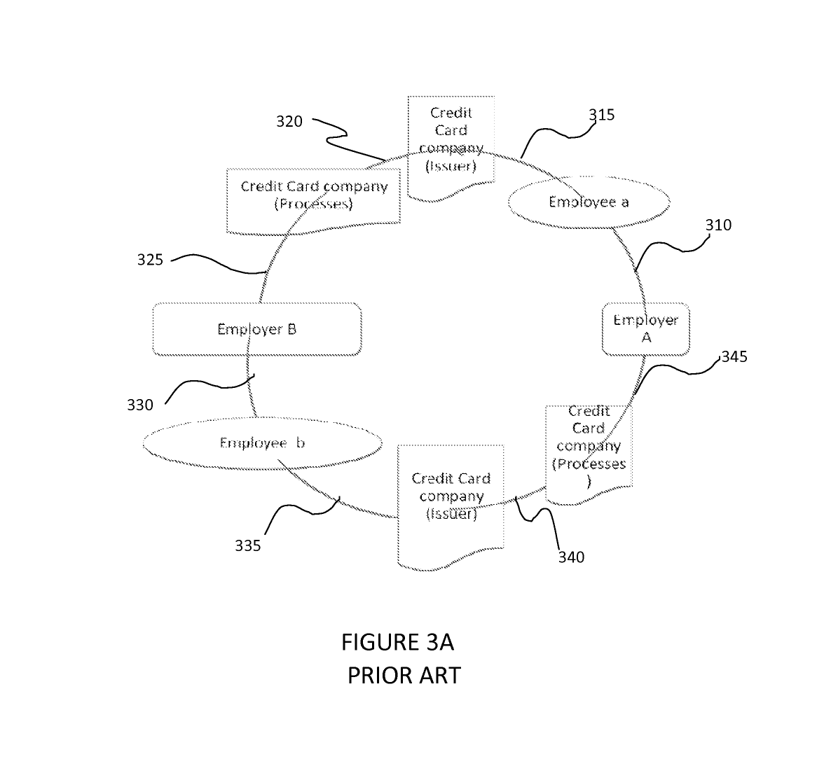

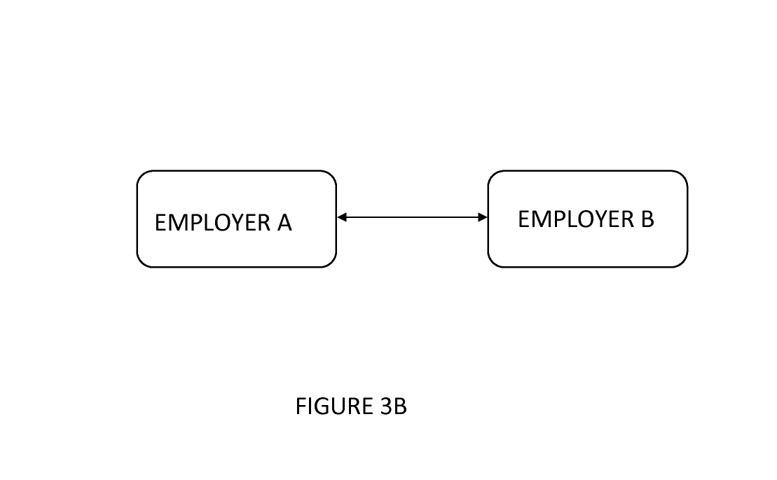

FIG. 3a shows an example of a transaction between employee A to employee B according to methods known in the prior art;

At 310, Employer A deposits a salary or a portion of a salary of employee a in the bank account of employee a.

At 315, employee a purchases an item from employer B. For example, employer B may be a retailer of electronic appliances and employee a may purchase a television from employer B. The purchase is performed with a credit card of Visa (the Issuer). Visa charges the employee a for the transaction and charges commission fees from employer B.

At 320, the transaction is transferred to the clearing house or to an acquirer bank.

At 325, the clearing house/the acquirer bank charges commission fees from employer B for the transaction. The money for the transaction deducted by the commission fees from Visa and from the clearing house/the acquirer bank is transferred to employer B.

At 330, employer B deposits salary or a portion of a salary to employee b.

At 335, employee b orders a service from employer A. For example, employer A may be a lawyer and employee b may order a consulting service from employer A. The purchase is performed with a credit card of American Express. American Express charges the employee b for the transaction and charges commission fees from employer A

At 340, the transaction is transferred to the clearing house/the acquirer bank

At 345, the clearing house/the acquirer bank charges commission fees from employer A for the transaction. The money for the transaction deducted by the commission fees from American Express and from the clearing house/the acquirer bank is transferred to employer A.

FIG. 3b shows an example of an electronic transaction between employer A to employer B, in accordance with some exemplary embodiments of the disclosed subject matter.

Employer A, Employer B, employee a and employee b are registered to the system. Employer A and employer B transfer the money to employee a account and employee b account respectively. Employee a account and employee b account are held by an Escrow nominated by the operator of the system. Employee a purchases the goods using his account. Employee b purchases the service using his account. There is only one banking entity (the Escrow) that is involved in the purchases and thus there is no need for the seller to pay multiple commission fees. Thus employer A, when functions as a seller of the goods, and employer B, when functions as a seller of the service, pay commission fees only to the operator service (instead of paying to two credit card/banking entities). Thus they can pay commissions to the buyer and to the payer of the buyer. Additionally when the seller functions as a payer, the seller receives commissions when its payee purchases from another seller that is registered to the system.

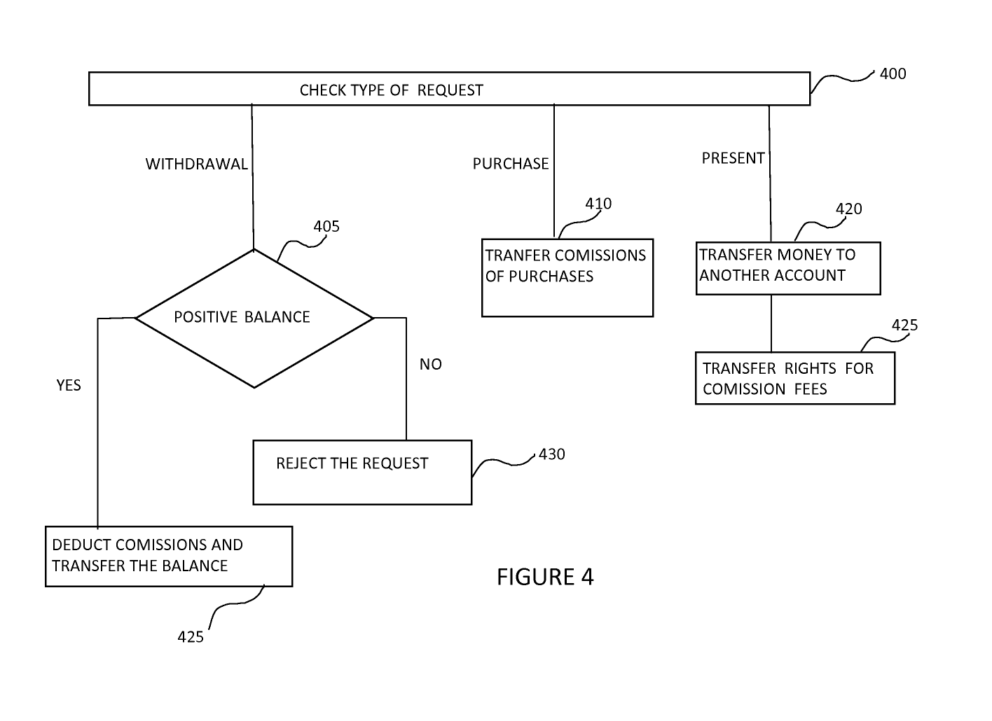

FIG. 4 shows a first exemplary scenario for an electronic payment, in accordance with some exemplary embodiments of the disclosed subject matter. The scenario illustrates options for depositing money from an account of an employee.

At 400 the type of request is checked.

If the type of the request is a withdrawal then at 405 the balance in the account of the employee is checked.

If the balance is not positive the request is rejected at 430.

If the balance is positive then at 425 commissions fees for the payer and for the operator of the system are deducted from the balance and the user is prompted to withdraw the new balance. The commission fees are deducted because the employee chooses to withdraw the salary that was pre paid to him instead of purchasing. In such a case the employer and the operator of the system cannot receive commissions from future purchases and thus are compensated.

In one example, the employee pays 0.25% of the balance to the employer and 0.25% of the balance to the operator of the system.

If the type of the request is purchasing and the balance is sufficient for the purchase and the purchase order is authenticated then at 410 the purchase is performed and the commissions are transferred from the seller to the employee, to the employer and to the operator of the system. For example the seller transfers 0.5% of the transaction amount to the employee, 0.25% of the transaction amount for the employer and 0.25% of the transaction amount for the operator of the system.

If the type of the request is rewarding another user of the system (for example a present to another user) then at 420 the rewarded amount is transferred to the other account and at 425 the rights for commission fees are also transferred to the other user. The other user may purchase with this amount while being credited for the purchases.

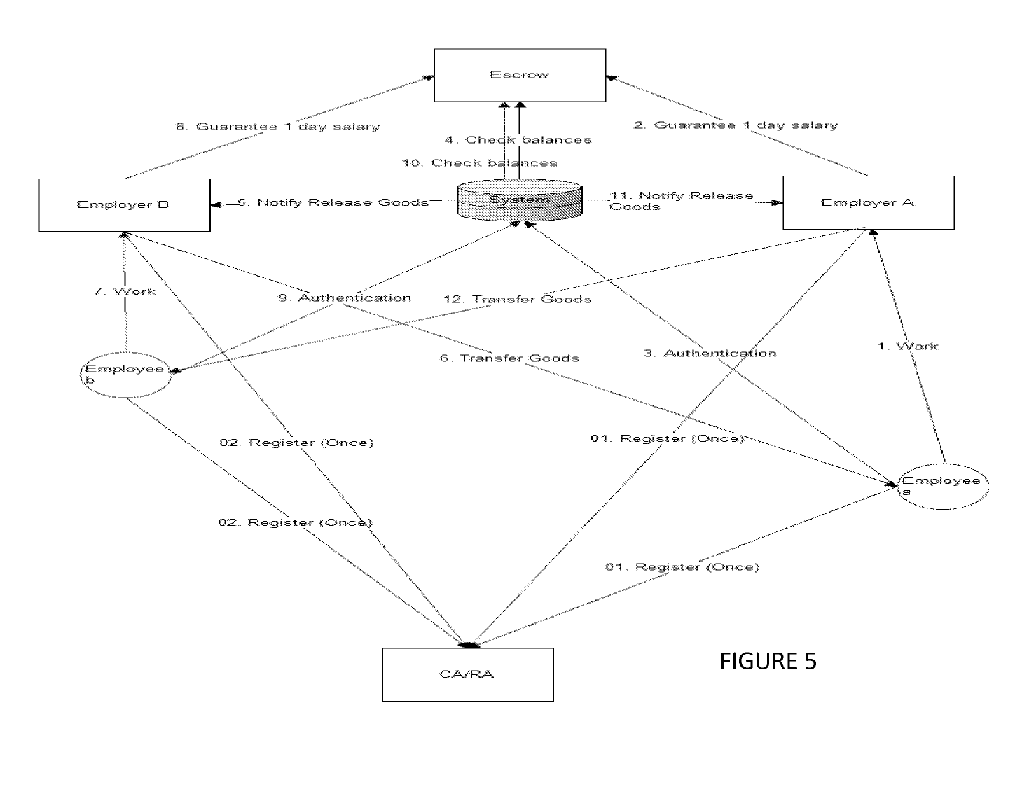

FIG. 5 shows a second exemplary scenario for an electronic payment, in accordance with some exemplary embodiments of the disclosed subject matter.

At 01 and 02, employer A and employer B register to the system. They also register their employees to the system.

At 1 employer A and employee a agree upon transferring a portion of a salary of employee a to an account of the system.

At 2 employer A transfers a 1 day salary of employee a to the account of employee a.

At 3 employee a authenticates to the system in order to make a purchase from employer B.

At 4 the system checks the balance of the account as a result of a request of employee a to purchase goods from employer B.

At 5 the system notifies employer B to release goods to employee a.

At 6 employer B transfers the goods to employee a.

At 7 employer B and employee b agree upon transferring a portion of a salary of employee b to an account of employee b.

At 8 employer B transfers a one day salary of employee b to the account of employee b.

At 9 employee b authenticates to the system in order to make a purchase from employer A.

At 10 the system checks the balance of the account of employee b as a result of a request of employee b to purchase goods from employer A.

At 11 the system notifies employer A to release goods to employee b.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.”Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be automatically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like. Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, at an apparatus having a processing unit and memory, comprising:
receiving a deposit order submitted from a payer account to a payee account; wherein said deposit order comprises a deposit amount;
by said processing unit, automatically crediting said deposit amount to a payee account;
receiving an electronic transaction order from said payee; wherein said electronic transaction order comprising an identification of a seller and wherein said electronic transaction order comprising a transaction amount;
by said processing unit, calculating a payee commission fee from said transaction amount;
by said processing unit, automatically crediting said payee account by said payee commission fee; and
by said processing unit, automatically debiting a seller account of said seller by said payee commission fee.

2. The method of claim 1, further comprising the steps of:
by said processing unit, calculating a payer commission fee from said transaction amount;
by said processing unit, automatically crediting said payer account by said payer commission fee; and
by said processing unit, automatically debiting said seller account by said payer commission fee.

3. The method of claim 1, wherein said calculating said payee commission fee being according to a type of transaction.

4. The method of claim 1, further comprising the steps of:
storing data related to said deposit order in a data repository; and
associating said data with a first identification of said payee; and
associating said data with a second identification of said payer.

5. The method of claim 1, further comprises the step of automatically debiting the payee account by said transaction fee.

6. A computer-implemented method, comprising: at an apparatus having one or more processing units and a memory:
receiving a deposit order submitted from a payer account to a payee account; wherein said deposit order comprises a deposit amount;
by said processing unit, automatically crediting said deposit amount to a payee account;
receiving an electronic transaction order from said payee; wherein said electronic transaction order comprising an identification of a seller and wherein said electronic transaction order comprising a transaction amount;
by said processing unit, calculating a payer commission fee from said transaction amount;
by said processing unit, automatically crediting said payer account by said payer commission fee; and
by said processing unit, automatically debiting a seller-account of said seller by said payer commission fee.

7. The method of claim 6, wherein said calculating said payer commission fee being according to a type of transaction.

8. The method of claim 6, further comprising the steps of
storing data related to said electronic transaction order in a data repository;
associating said data with a first identification of said payee; and
associating said data with a second identification of said payer;

9. A computer-readable storage media comprising computer-executable instructions for performing a payment method, the computer-executable instructions directed to steps comprising: receiving a deposit order submitted from a payer account to a payee account; wherein said deposit order comprises a deposit amount;
by said processing unit, automatically crediting said deposit amount to a payee account;
receiving an electronic transaction order from said payee; wherein said electronic transaction order comprising an identification of a seller and wherein said electronic transaction order comprising a transaction amount;
by said processing unit, calculating a payee commission fee from said transaction amount;
by said processing unit, automatically crediting said payee account by said payee commission fee; and
by said processing unit, automatically debiting a seller account of said seller by said payee commission fee.
